(19) United States
(12) Patent Application Publication
(10) Pub. No.: US 2025/0337075 A1
(43) Pub. Date: Oct. 30, 2025

(54) BATTERY PACK AND BATTERY CELL STACK MOUNTED ON BATTERY PACK

(71) Applicants: Hyundai Motor Company, Seoul (KR); Kia Corporation, Seoul (KR)

(72) Inventors: Jong Gyu Park, Hwaseong-si (KR); Kyung Mo Kim, Hwaseong-si (KR); Gun Woo Ko, Hwaseong-si (KR); Chan Sol Kim, Hwaseong-si (KR)

(21) Appl. No.: 18/936,109

(22) Filed: Nov. 4, 2024

(30) Foreign Application Priority Data
Apr. 29, 2024 (KR) 10-2024-0056974

(51) Int. Cl. H01M 50/242; H01M 10/613; H01M 10/6557; H01M 50/209; H01M 50/249

(52) U.S. Cl. CPC H01M 50/242; H01M 10/613; H01M 10/6557; H01M 50/209; H01M 50/249; H01M 2220/20

(57) ABSTRACT

A battery pack includes a base plate, battery cells supported by the base plate, extending in a first direction, and arranged in a second direction crossing the first direction, a side member supported by the base plate and disposed on one side of the battery cells in the first direction, and a plate including a portion disposed between adjacent battery cells of the battery cells and in contact with the battery cells and a partial area disposed between the battery cells and the side member and in contact with the side member.

### CROSS-REFERENCE TO RELATED APPLICATIONS

This application claims the benefit of Korean Patent Application No. 10-2024-0056974, filed on Apr. 29, 2024, which application is hereby incorporated herein by reference.

### TECHNICAL FIELD

The present disclosure relates to a battery pack and a battery cell stack that is mounted on the battery pack.

### BACKGROUND

Recently, as awareness of the crisis regarding the environment and depletion of petroleum resources has increased, research and development on electric vehicles that are eco-friendly vehicles has been highlighted. Electric vehicles include a plug-in hybrid electric vehicle (PHEV), a battery electric vehicle (BEV), and a fuel cell electric vehicle (FCEV).

An electric vehicle may include a battery housing that supports battery cells. Meanwhile, an electric vehicle uses battery cells as a power source, and efforts have been made recently to increase the capacity of battery cells accommodated in an interior of the battery housing.

To improve the capacity of battery cells, battery cells may be accommodated in the interior of the battery housing in the form of cell to pack (CTP) rather than in the form of modules. Meanwhile, electric vehicles may be subject to an impact from a lateral side, and a need to reduce a degree of an impact that is transmitted to the battery cells, in a degree of an impact that is applied to the battery pack, is increasing.

### SUMMARY

Embodiments of the present disclosure can solve problems occurring in the prior art while advantages achieved by the prior art are maintained intact.

An embodiment of the present disclosure provides a battery pack and a battery cell stack mounted on the battery pack, which may reduce a degree of an impact transmitted to battery cells, in an amount of an impact applied to the battery pack, when the impact is applied to a side surface of the battery pack.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery pack includes a base plate, battery cells supported by the base plate, extending in a first direction, and arranged in a second direction crossing the first direction, a side member supported by the base plate and disposed on one side of the battery cells in the first direction, and a plate. The plate comprises a portion disposed between adjacent battery cells of the battery cells and in contact with the battery cells, and a partial area disposed between the battery cells and the side member and the in contact with the side member.

The plate may include a cooling part disposed between the battery cells and an impact absorbing part bent from the cooling part and disposed between the battery cells and the side member. The impact absorbing part may include a portion protruding to the one side in the first direction and contacting the side member.

The impact absorbing part may further include one end connected to the cooling part, an opposite end contacting the side member, and a convex area that is convex in the first direction between the one end of the impact absorbing part and the opposite end of the impact absorbing part.

The convex area may include a first convex area that is connected to the one end of the impact absorbing part and is convex toward the side member and a second convex area that is connected to the first convex area and is convex toward the battery cells.

The impact absorbing part may include a flange area disposed on the one side of the battery cells in the first direction and a protruding area protruding from the flange area toward the side member.

The protruding area may include one end connected to the flange area and an opposite end contacting the side member. The opposite end of the protruding area may be spaced apart from the one end of the protruding area, in the second direction.

The protruding area may be bent between the one end of the protruding area and the opposite end of the protruding area.

A portion of the flange area may be cut away to define a cutaway portion, and the protruding area may have a shape in which the cutaway portion of the flange area is bent to have a curved surface.

The battery pack may further include the protruding area which may further include a protruding/extending area extending in the second direction between the one end of the protruding area and the opposite end of the protruding area.

The protruding/extending area may include a first protruding/extending area extending from the one end of the protruding area to the one side in the first direction, a second protruding/extending area extending from the first protruding/extending area in the second direction, and a third protruding/extending area extending from the second protruding/extending area to the one side in the first direction.

The battery pack may further include a plurality of battery cell stacks including the battery cells, an end plate disposed on a side of the battery cells in the second direction, a crossing member supported by the base plate between a pair of end plates of a pair of battery cell stacks spaced apart from each other in the second direction, among the plurality of battery cell stacks, which face each other, and extending in the first direction, and a mounting bracket mounted on the side member to fix the crossing member.

The battery pack may further include a fixing member fixing the crossing member while passing through the base plate, and the base plate may include a fixing hole through which the fixing member passes.

According to an embodiment of the present disclosure, a battery cell stack includes battery cells extending in a first direction and arranged in a second direction crossing the first direction and a plate contacting the battery cells between the battery cells. The plate may include a cooling part disposed between the battery cells and an impact absorbing part including one end connected to the cooling part and an opposite end protruding in a direction from the one end, in which the opposite end becomes more distant from the battery cells, or including a flange area connected to the cooling part and disposed on one side of the battery cells in the first direction and a protruding area protruding from the flange area in a direction, in which the protruding area becomes more distant from the battery cells.

The impact absorbing part may further include a convex area that is convex in the first direction between the one end of the impact absorbing part and the opposite end of the impact absorbing part.

The convex area may include a first convex area connected to the one end of the impact absorbing part and that is convex in a direction in which the first area becomes more distant from the battery cells and a second convex area connected to the first convex area and convex in a direction in which the second convex area becomes closer to the battery cells.

The protruding area may include one end connected to the flange area and an opposite end spaced apart from the one end of the protruding area in the second direction and protruding to the one side in the first direction.

The protruding area may be bent between the one end of the protruding area and the opposite end of the protruding area.

A portion of the flange area may be cut away to define a cutaway portion, and the protruding area may have a shape in which the cutaway portion of the flange area is bent to have a curved surface.

The protruding area may further include a protruding/extending area extending in the second direction between the one end of the protruding area and the opposite end of the protruding area.

The protruding area may include a first protruding area extending from the one end of the protruding area to the one side in the first direction, a second protruding area extending from the first protruding area in the second direction, and a third protruding area extending from the second protruding area to the one side in the first direction.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is an exploded perspective view of a battery pack according to an embodiment of the present disclosure;

FIG. 2 is a perspective view of a battery housing and a battery cell stack according to an embodiment of the present disclosure;

FIG. 3 is a vertical cross-sectional view of a battery pack according to an embodiment of the present disclosure;

FIG. 4 is a perspective view of a battery cell stack and peripheral components according to an embodiment of the present disclosure;

FIG. 5 is a horizontal cross-sectional view of a battery cell stack and a side member according to an embodiment of the present disclosure;

FIG. 6 is a perspective view of a battery cell stack and peripheral components according to another embodiment of the present disclosure;

FIG. 7 is a horizontal cross-sectional view of a battery cell stack and a side member according to another embodiment of the present disclosure;

FIG. 8 is a horizontal cross-sectional view of a battery cell stack and a side member according to another embodiment of the present disclosure;

FIG. 9 is a perspective view of a base plate, a side member, and a mounting bracket according to an embodiment of the present disclosure;

FIG. 10 is a perspective view of a mounting bracket and a crossing member coupled to a base plate according to an embodiment of the present disclosure; and

FIG. 11 is a vertical cross-sectional view of a crossing member, a mounting bracket, and peripheral components according to an embodiment of the present disclosure.

### DETAILED DESCRIPTION OF ILLUSTRATIVE EMBODIMENTS

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A,” “B,” (a), and (b) may be used. The terms are simply for distinguishing the components, and the essence, the sequence, and the order of the corresponding components are not limited by the terms. Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

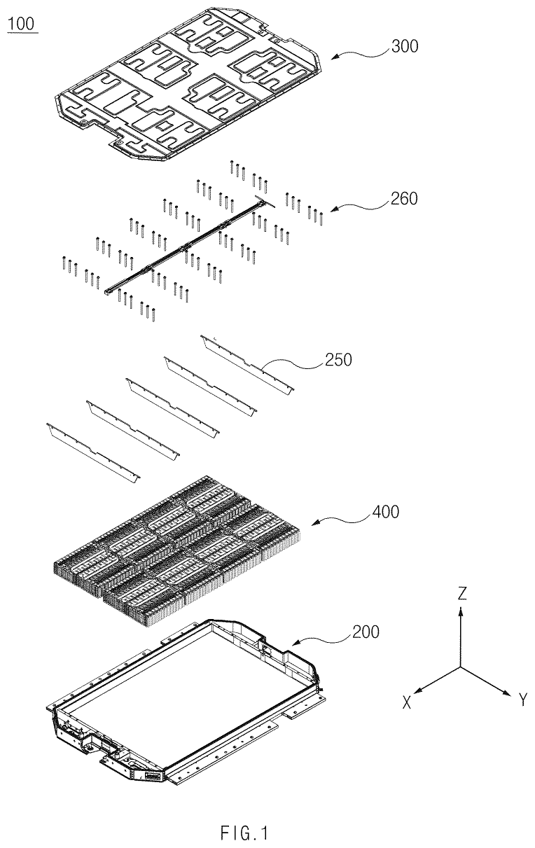

Hereinafter, embodiments of the present disclosure will be described in detail with reference to FIGS. 1 to 11. Hereinafter, a leftward/rightward direction may be a first direction, a forward/rearward direction may be a second direction, and an upward/downward direction may be a third direction.

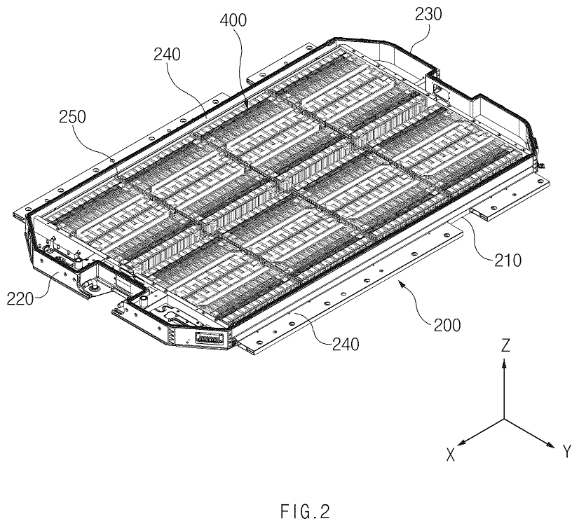

FIG. 1 is an exploded perspective view of a battery pack according to an embodiment of the present disclosure. FIG. 2 is a perspective view of a battery housing and a battery cell stack according to an embodiment of the present disclosure.

Referring to FIGS. 1 and 2, a battery pack 100 may include a battery housing 200 and a pack cover 300 that is disposed on an upper side (the “Z” direction) of the battery housing 200. The battery pack 100 may include a battery cell stack 400 that is supported by the battery housing 200.

The battery housing 200 may define a space in which the battery cell stack 400 is accommodated. The battery housing 200 may include a base plate 210 that supports the battery cell stack 400, a front member 220 that is supported by the base plate 210 and covers a front (the “X” direction) area of the battery cell stack 400, and a rear member 230 that covers a rear (an opposite direction to the “X” direction) area of the battery cell stack 400.

The battery housing 200 may include side members 240 that are disposed on opposite sides of the base plate 210 in the leftward/rightward direction and are supported by the base plate 210. A pair of side members 240 may be provided on opposite sides of the battery cell stack 400 in the leftward/rightward direction, respectively. The pair of side members 240 may cover opposite areas of the battery cell stack 400 in the leftward/rightward direction, respectively.

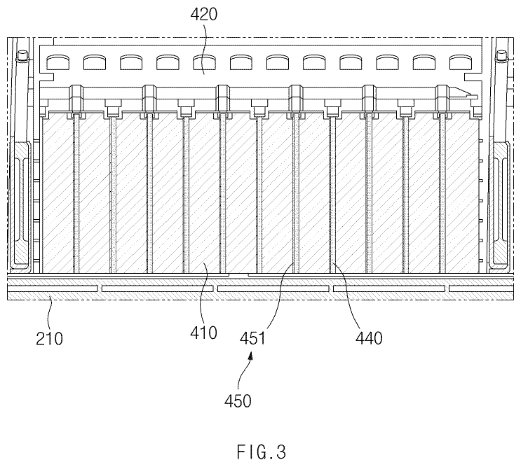

The battery cell stack 400 may include a plurality of battery cells 410 (see FIG. 3). The battery cells 410 may be lithium ion batteries, but embodiments of the present disclosure are not limited thereto. The plurality of battery cells 410 may be accommodated in the battery housing 200 with no separate module frame.

That is, the battery cells 410 according to embodiments of the present disclosure may be mounted inside the battery pack 100 in the form of a cell-to-pack (CTP). However, a method in which the battery cells 410 are mounted on the battery pack 100 is not limited thereto, and the battery cells 410 may be accommodated in the battery housing 200 while a separate module frame is provided.

The battery housing 200 may include a crossing member 250 disposed between the front member 220 and the rear member 230. The crossing member 250 may extend in a leftward/rightward direction (the “Y” direction or an opposite direction to the “Y” direction) between the front member 220 and the rear member 230. The crossing members 250 may be disposed between the plurality of battery cell stacks 400 and may support a pair of battery cell stacks 400 that are disposed in parallel to each other with the crossing member 250 being interposed therebetween.

The battery pack 100 may include a fixing member 260 that is configured to fix the crossing member 250 to the battery housing 200.

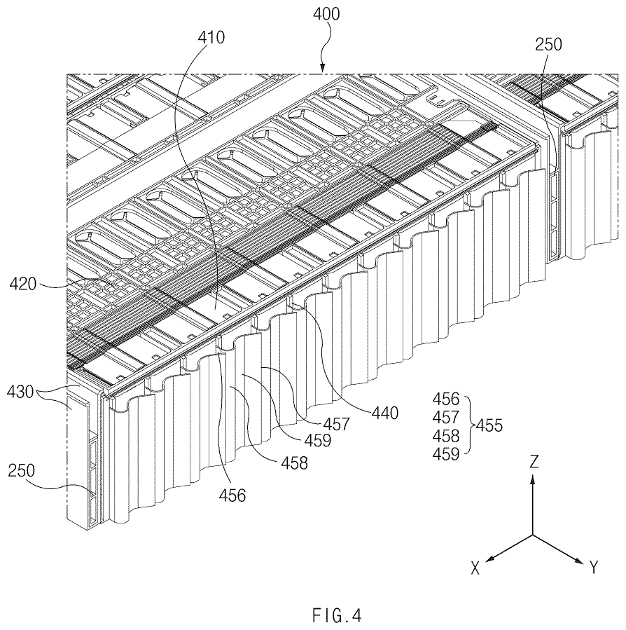

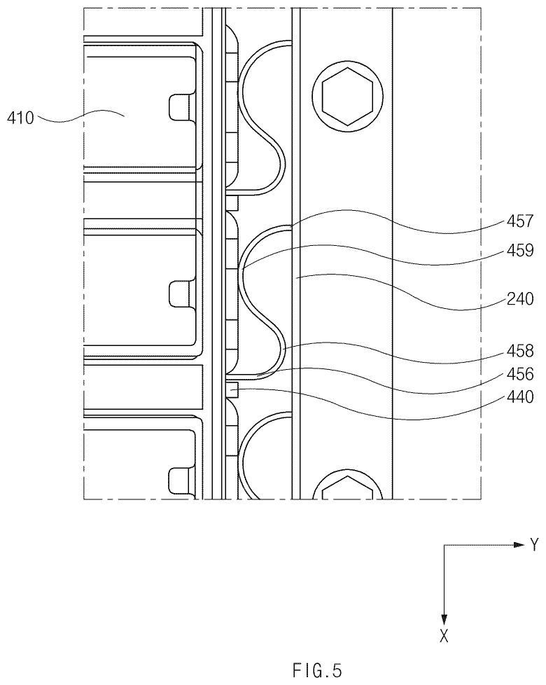

FIG. 3 is a vertical cross-sectional view of a battery pack according to an embodiment of the present disclosure. FIG. 4 is a perspective view of a battery cell stack and peripheral components according to an embodiment of the present disclosure. FIG. 5 is a horizontal cross-sectional view of a battery cell stack and a side member according to an embodiment of the present disclosure.

Referring to FIGS. 3 to 5, the battery cell stack 400 may include battery cells 410 that are supported by the base plate 210, extend in the first direction that is the leftward/rightward direction, and are arranged in the second direction that is the forward/rearward direction. Then, the first direction and the second direction may be perpendicular to each other. The battery cells 410 may be angular or cylindrical battery cells.

The battery cell stack 400 may include a sensing assembly 420 that is disposed on an upper side of the battery cells 410 and end plates 430 disposed on opposite sides of the battery cell 410 in the forward/rearward direction. The sensing assembly 420 may be electrically connected to the battery cells 410. The end plates 430 may be disposed on opposite sides of the battery cell stacks 400 that are stacked in the forward/rearward direction, in the forward/rearward direction. The pair of end plates 430 may press the battery cells 410 on opposite sides of the plurality of battery cells 410.

The battery cell stacks 400 may include surface-pressure member 440 and plates 450 that are disposed between the battery cells 410, respectively. The surface-pressure members 440 may be components for preventing swelling of the battery cells 410 by pressing the battery cells 410 that do not contact the end plates 430.

The plate 450 may include a cooling part 451, at least a portion of which contacts the battery cells 410 between the battery cells 410 to cool the battery cells 410. The cooling part 451 may extend in the upward/downward direction while contacting the battery cells 410 between the battery cells 410. The cooling part 451 may receive heat from the battery cells 410 and transfer the heat to a coolant that flows through a cooling channel of the base plate 210.

The plate 450 may include an impact absorbing part 455 that protrudes from the cooling part 451 to one side of the cooling part 451 in the leftward/rightward direction. The impact absorbing part 455 may protrude from the cooling part 451 and may be disposed between the battery cell 410 and the side member 240.

The impact absorbing part 455 may protrude from the cooling part 451 to one side of the leftward/rightward direction and may be bent in the forward/rearward direction. A part of the impact absorbing part 455 may protrude to one side in the leftward/rightward direction to contact the side member 240.

The impact absorbing part 455 needs to contact the side member 240 only through a specific portion. This is because a function of the plate 450 for cooling the battery cell 410 may not be easy as an area, in which the impact absorbing part 455 contacts the side member 240, increases.

In more detail, the impact absorbing part 455 may include an end 456 that is connected to the cooling part 451 and an opposite end 457 that is connected to the side member 240. The impact absorbing part 455 may include the end 456 that is connected to the cooling part 451 and the opposite end 457 that is spaced apart from the end 456 of the impact absorbing part 455 in the forward/reward direction and protrudes in a direction in which it becomes more distant from the battery cell 410.

The impact absorbing part 455 may include first and second convex areas 458 and 459 that are formed to be convex in the first direction between the end 456 of the impact absorbing part 455 and the opposite end 457 of the impact absorbing part 455.

The first convex area 458 may be connected to the end 456 of the impact absorbing part 455 to be convex toward the side member 240, and the second convex area 459 may be connected to the first convex area 458 to be convex toward the battery cell 410.

Due to the shapes of the first and second convex areas 458 and 459, a length of the impact absorbing part 455 may be greater than a length in a case in which an area that connects the end 456 and the opposite end 457 has a planar shape.

As described above, according to the structure in which the opposite ends 457 of the impact absorbing part 455 contact the side member 240, when an impact is applied from one side of the battery pack 100 (see FIG. 1) in the leftward/rightward direction, a portion of the impact may be transmitted to the plate 450 through the side member 240. Then, because the plate 450 is formed of a metal material, the impact may be transmitted to the cooling part 451 while mitigating a specific portion of the impact even when the impact is transmitted through the side member 240.

In addition, according to the structure in which the length between the end 456 and the opposite end 457 of the impact absorbing part 455 is relatively large, a degree of the impact transmitted to the cooling part 451 may be relatively further mitigated when the impact is transmitted from the side member 240 to the cooling part 451. Accordingly, the degree of the impact transmitted to the battery cell 410 is reduced, and thus, the safety of the battery cell 410 may be improved.

Furthermore, the battery pack 100 (see FIG. 1) may further include a longitudinal member (not illustrated) that is supported by the base plate 210 (see FIG. 2) and extends in a direction that is perpendicular to the crossing member 250. Then, the cooling part 451 of the plate 450 may contact the longitudinal member. According to the structure, because a degree of the impact, which is absorbed from the impact absorbing part 455 of the plate 450, may be transmitted to the longitudinal member through the cooling part 451, the degree of the impact transmitted to the battery cell 410 may be relatively reduced.

Furthermore, embodiments of the present disclosure are not limited to this, and the plates 450 of the pair of battery cell stacks 400 disposed in parallel in the leftward/rightward direction, among the plurality of battery cell stacks 400 according to embodiments of the present disclosure, may be connected to each other. According to the structure, even when an impact is applied from one side of the battery pack 100 (see FIG. 1) in the leftward/rightward direction, the degree of the impact transmitted to the battery cell 410 may be relatively reduced as the impact is transmitted to the plate 450 that is adjacent to the opposite side, to which the impact is not applied, through the plate 450 that is adjacent to the one side, to which the impact is applied.

That is, not only is the plate 450 a simple component for adjusting a temperature of the battery cell 410, but it may also be formed such that a partial area thereof is disposed between the battery cell 410 and the side member 240, and a portion of a part disposed between the battery cell 410 and the side member 240 contacts the side member 240.

According to the above-described structure, a maximum capacity of the battery cell 410 may be ensured within a limited volume of the battery pack 100 with separate module frame, and at the same time, even when an impact is applied to the battery pack 100, the degree of the impact transmitted to the battery cell 410 may be reduced, and thus, the safety of the battery pack 100 may be improved.

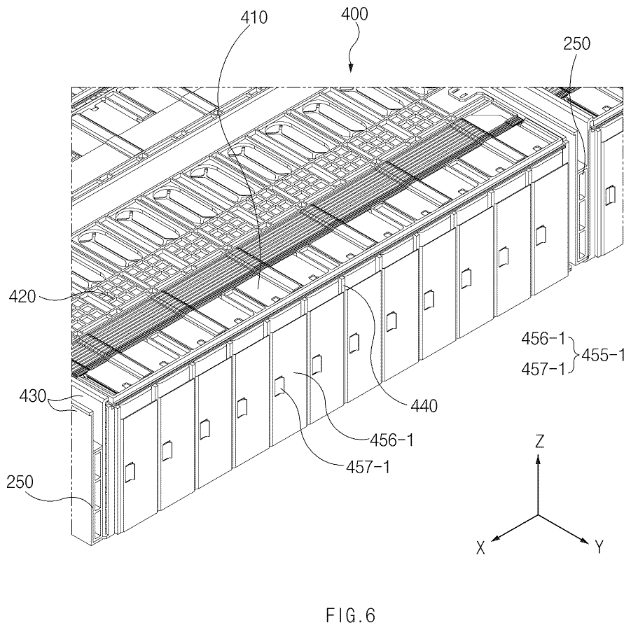

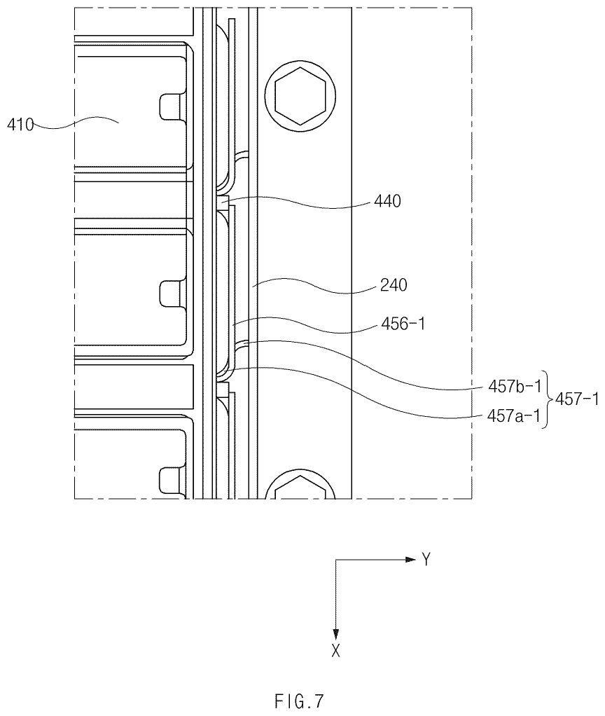

FIG. 6 is a perspective view of a battery cell stack and peripheral components according to another embodiment of the present disclosure. FIG. 7 is a horizontal cross-sectional view of a battery cell stack and a side member according to another embodiment of the present disclosure.

Referring to FIGS. 6 to 7, the battery cell stack 400 according to another embodiment of the present disclosure may include an impact absorbing part 455-1 having a shape that is different from that of the impact absorbing part 455 of the battery cell stack 400 illustrated in FIG. 5.

For a description of the components other than the impact absorbing part 455-1 of the battery cell stack 400 according to another embodiment of the present disclosure, a description of other components of the battery cell stack 400 illustrated in FIG. 4 is used.

The impact absorbing part 455-1 may include a flange area 456-1 that is connected to the cooling part 451 (see FIG. 3) and is disposed on one side of the battery cell 410 in the leftward/rightward direction and a protruding area 457-1 that protrudes from the flange area 456-1 toward the side member 240. In other words, the protruding area 457-1 may protrude from the flange area 456-1 in a direction in which it becomes more distant from the battery cell 410.

The flange area 456-1 may protrude from the cooling part 451 to one side in the leftward/rightward direction and may extend in the forward/rearward direction. The flange area 456-1 may be disposed in parallel to the battery cell 410.

The protruding area 457-1 may be formed such that a portion of the flange area 456-1 is cut away so that the cutaway portion of the flange area 456-1 is bent to have a curved surface.

The protruding area 457-1 may include an end 457a-1 that is connected to the flange area 456-1 and an opposite end 457b-1 that contacts the side member 240. Then, the opposite end 457b-1 of the protruding area 457-1 may be spaced apart from the end 457a-1 of the protruding area 457-1 in the forward/rearward direction and may protrude to one side in the leftward/rightward direction.

That is, the protruding area 457-1 may be formed to be bent between the end 457a-1 that is connected to the flange area 456-1 and the opposite end 457b-1 that contacts the side member 240.

In the drawing, it is illustrated that the opposite end 457b-1 of the protruding area 457-1 is disposed on a rear side of the one end 457a-1 of the protruding area 457-1, but embodiments of the present disclosure are not limited thereto, and the opposite end 457b-1 of the protruding area 457-1 may be disposed on a front side of the end 457a-1 of the protruding area 457-1.

Even with the above-described structure, because the degree of the impact transmitted to the cooling part 451, in the degree of the impact transmitted from the side member 240, may be relatively mitigated, the degree of the impact transmitted to the battery cell 410 may be reduced, and thus, the safety of the battery pack 100 may be improved.

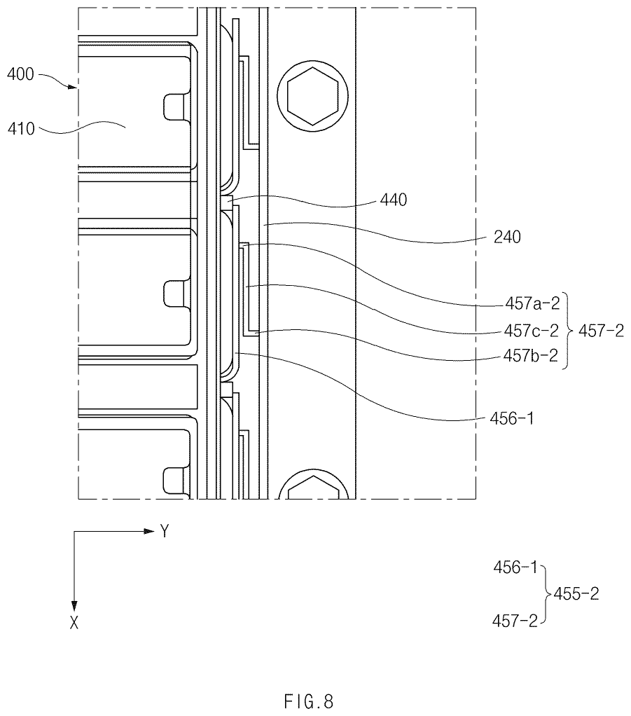

FIG. 8 is a horizontal cross-sectional view of a battery cell stack and a side member according to another embodiment of the present disclosure.

Referring to FIG. 8, the battery cell stack 400 according to another embodiment of the present disclosure may include an impact absorbing part 455-2 having a shape that is different from that of the impact absorbing part 455-1 of the battery cell stack 400 illustrated in FIG. 6.

For a description of the components other than the impact absorbing part 455-2 of the battery cell stack 400 according to another embodiment of the present disclosure, a description of other components of the battery cell stack 400 illustrated in FIG. 4 is used.

The impact absorbing part 455-2 may include a flange area 456-1 that is disposed on one side of the battery cell 410 in the leftward/rightward direction and a protruding area 457-2 that protrudes from the flange area 456-1 toward the side member 240.

The flange area 456-1 may protrude from the cooling part 451 (see FIG. 3) to one side in the leftward/rightward direction and may extend in the forward/rearward direction. The flange area 456-1 may be disposed in parallel to the battery cell 410.

The protruding area 457-2 may include an end 457a-2 that is connected to the flange area 456-1 and an opposite end 457b-2 that contacts the side member 240. Then, the opposite end 457b-2 of the protruding area 457-2 may be spaced apart from the end 457a-2 of the protruding area 457-2 in the forward/rearward direction and may protrude toward one side in the leftward/rightward direction.

The protruding area 457-2 may include a protruding/extending area 457c-2 that extends in the second direction between the end 457a-2 of the protruding area 457-2 and the opposite end 457b-2 of the protruding area 457-2.

The protruding/extending area 457c-2 may include a first protruding/extending area that extends from the end 457a-2 of the protruding area 457-2 to one side in the leftward/rightward direction, a second protruding/extending area that extends forward from the first protruding/extending area, and a third protruding/extending area that extends from the second protruding/extending area to the opposite end 457b-2 of the protruding area 457-2 toward one side of the leftward/rightward direction.

In the drawing, it is illustrated that the opposite end 457b-2 of the protruding area 457-2 is disposed on a front side of one end 457a-2 of the protruding area 457-2, but embodiments of the present disclosure are not limited thereto, and the opposite end 457b-2 of the protruding area 457-2 may be disposed on a rear side of the end 457a-2 of the protruding area 457-2. That is, the first protruding/extending area may be disposed on a front side of the third protruding/extending area.

According to the above-described structure, since the degree of the impact transmitted to the cooling part 451 among the degree of the impact transmitted from the side member 240 may be relatively further mitigated, the degree of the impact transmitted to the battery cell 410 may be reduced, thereby improving safety of the battery pack 100.

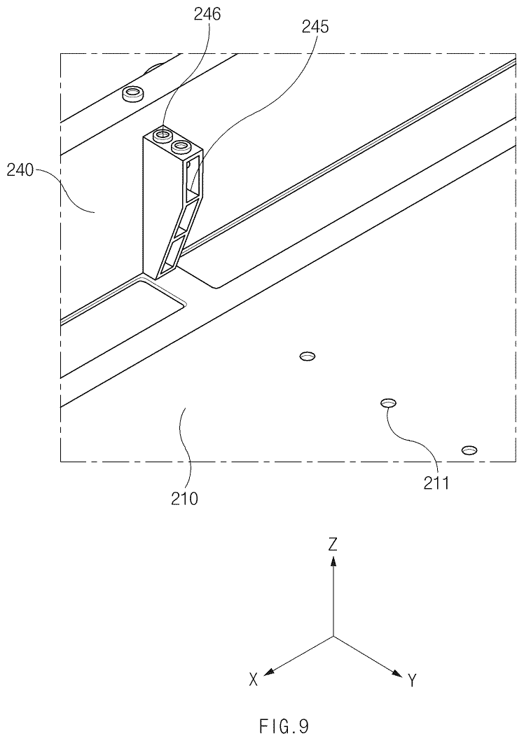

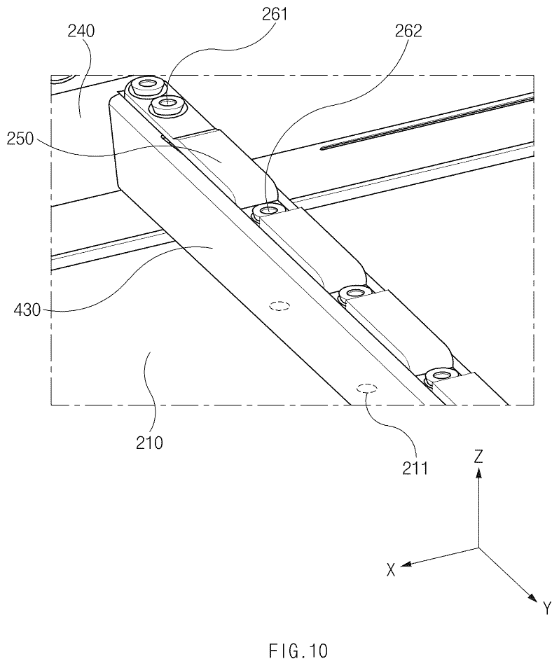

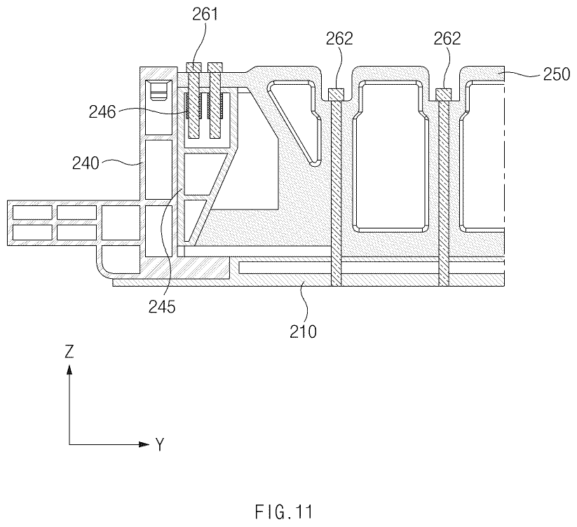

FIG. 9 is a perspective view of a base plate, a side member, and a mounting bracket according to an embodiment of the present disclosure. FIG. 10 is a perspective view of a mounting bracket and a crossing member coupled to a base plate according to an embodiment of the present disclosure. FIG. 11 is a vertical cross-sectional view of a crossing member, a mounting bracket, and peripheral components according to an embodiment of the present disclosure.

Referring to FIGS. 9 to 11, the crossing member 250 of the battery pack 100 (see FIG. 1) may be mounted on the battery housing 200 after the battery cell stack 400 is mounted on the battery housing 200.

In more detail, a plurality of battery cell stacks 400 may be accommodated in the battery housing 200 before the crossing member 250. Then, the plurality of battery cell stacks 400 may be disposed to be spaced apart from each other in forward/rearward directions.

The crossing member 250 may be provided between a pair of battery cell stacks 400 that are spaced apart from each other in the forward/rearward direction, among the plurality of battery cell stacks 400. The crossing member 250 may support the pair of battery cell stacks 400 provided parallel to each other with the crossing member 250 being interposed therebetween.

The crossing member 250 may be disposed between the pair of end plates 430 that are disposed to face each other with the crossing member 250 being interposed therebetween. That is, the crossing member 250 may be supported by the base plate 210 between the pair of facing end plates 430 of the battery cell stack 400 that are spaced apart from each other in the forward/rearward direction.

Then, a mounting bracket 245 configured to fix the crossing member 250 may be mounted on the side member 240. The mounting bracket 245 may be disposed between the pair of adjacent end plates 430. A fixing member support part 246 may be provided in the mounting bracket 245.

Meanwhile, the fixing member 260 (see FIG. 1) may include a first fixing member 261 for fixing the crossing member 250 on the mounting bracket 245 and a second fixing member 262 for fixing the crossing member 250 on the base plate 210.

The base plate 210 may include a fixing hole 211 through which the second fixing member 262 passes so that the second fixing member 262 passes through the base plate 210. A plurality of fixing holes 211 may be provided to be spaced apart from the mounting bracket 245 in the leftward/rightward direction.

The mounting bracket 245 and the fixing hole 211 may guide a position in which the plurality of battery cell stacks 400 are to be mounted in an interior of the battery housing 200. Accordingly, the battery cell stack 400 may be mounted on the battery housing 200 more easily. Furthermore, positions of the mounting bracket 245 and the fixing hole 211 may be moved in the forward/rearward direction according to the arrangement of the battery cell stacks 400.

According to the above-described structure, the plurality of battery cell stacks 400 may be mounted on the battery housing 200 not to interfere with the mounting bracket 245, and then the crossing member 250 may be seated on the mounting bracket 245 or the base plate 210 between the pair of adjacent end plates 430.

Thereafter, the first fixing member 261 may be inserted into the crossing member 250 and the mounting bracket 245 through an upper side of the crossing member 250. The first fixing member 261 may be supported by the fixing member support part 246. For example, the first fixing member 261 may be formed in the shape of a bolt, and the fixing member support part 246 may be formed in the shape of a nut.

The second fixing member 262 may be inserted into an area in which the crossing member 250 and the fixing hole 211 overlap each other through an upper side of the crossing member 250 or a lower side of the base plate 210.

Through the above-described process, the plurality of battery cell stacks 400 and crossing members 250 may be accommodated in the battery housing 200. In this way, according to the structure in which the crossing member 250 is mounted on the battery housing 200 after the battery cell stack 400 is mounted on the battery housing 200, a manufacturing efficiency of the battery pack 100 (see FIG. 1) may be improved.

The present technology may reduce a degree of the impact transmitted to battery cells, in the degree of the impact applied to the battery pack, when the impact is applied to the side surface of the battery pack, so that the safety of the battery pack may be improved.

In addition, the present technology may secure the safety of the battery cells while maintaining the cooling effect of the battery cells because only a partial area of the plate of the battery cell stack contacts the side member.

In addition, various effects that are directly or indirectly identified through the document may be provided.

The above description is a simple exemplary description of the technical spirits of the present disclosure, and a person of ordinary skill in the art to which the present disclosure pertains may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a base plate;
battery cells supported by the base plate, extending in a first direction, and arranged in a second direction crossing the first direction;
a side member supported by the base plate and disposed on one side of the battery cells in the first direction; and
a plate comprising:
a portion disposed between adjacent battery cells of the battery cells and in contact with the battery cells; and
a partial area disposed between the battery cells and the side member and in contact with the side member.

2. The battery pack of claim 1, wherein the plate comprises:
a cooling part disposed between the battery cells; and
an impact absorbing part bent from the cooling part and disposed between the battery cells and the side member, wherein the impact absorbing part comprises a portion protruding to the one side in the first direction and contacting the side member.

3. The battery pack of claim 2, wherein the impact absorbing part further comprises:
one end connected to the cooling part;
an opposite end contacting the side member; and
a convex area that is convex in the first direction between the one end of the impact absorbing part and the opposite end of the impact absorbing part.

4. The battery pack of claim 3, wherein the convex area comprises:
a first convex area that is connected to the one end of the impact absorbing part and is convex toward the side member; and
a second convex area that is connected to the first convex area and is convex toward the battery cells.

5. The battery pack of claim 2, wherein the impact absorbing part comprises:
a flange area disposed on the one side of the battery cells in the first direction; and
a protruding area protruding from the flange area toward the side member.

6. The battery pack of claim 5, wherein the protruding area comprises:
one end connected to the flange area; and
an opposite end contacting the side member and spaced apart from the one end of the protruding area in the second direction.

7. The battery pack of claim 6, wherein the protruding area is bent between the one end of the protruding area and the opposite end of the protruding area.

8. The battery pack of claim 7, wherein:
a portion of the flange area is cut away to define a cutaway portion; and
the protruding area has a shape in which the cutaway portion of the flange area is bent to have a curved surface.

9. The battery pack of claim 7, wherein the protruding area further comprises a protruding/extending area extending in the second direction between the one end of the protruding area and the opposite end of the protruding area.

10. The battery pack of claim 9, wherein the protruding/extending area comprises:
a first protruding/extending area extending from the one end of the protruding area to the one side in the first direction;
a second protruding/extending area extending from the first protruding/extending area in the second direction; and
a third protruding/extending area extending from the second protruding/extending area to the one side in the first direction.

11. The battery pack of claim 1, further comprising:
a plurality of battery cell stacks comprising the battery cells and an end plate disposed on a side of the battery cells in the second direction;
a crossing member supported by the base plate between a pair of end plates of a pair of battery cell stacks spaced apart from each other in the second direction, among the plurality of battery cell stacks, which face each other, and extending in the first direction; and
a mounting bracket mounted on the side member to fix the crossing member.

12. The battery pack of claim 11, further comprising a fixing member fixing the crossing member while passing through the base plate, wherein the base plate comprises a fixing hole through which the fixing member passes.

13. A battery cell stack comprising:
battery cells extending in a first direction and arranged in a second direction crossing the first direction; and
a plate contacting the battery cells between the battery cells, wherein the plate comprises:
a cooling part disposed between the battery cells; and
an impact absorbing part having one end connected to the cooling part and an opposite end protruding in a direction from the one end, in which the opposite end becomes more distant from the battery cells or a flange area connected to the cooling part and disposed on one side of the battery cells in the first direction and a protruding area protruding from the flange area in a direction in which the protruding area becomes more distant from the battery cells.

14. The battery cell stack of claim 13, wherein the impact absorbing part further comprises a convex area that is convex in the first direction between the one end of the impact absorbing part and the opposite end of the impact absorbing part.

15. The battery cell stack of claim 14, wherein the convex area comprises:
a first convex area connected to the one end of the impact absorbing part and convex in a direction in which the first convex area becomes more distant from the battery cells; and
a second convex area connected to the first convex area and convex in a direction in which the second convex area becomes closer to the battery cells.

16. The battery cell stack of claim 13, wherein the protruding area comprises one end connected to the flange area and an opposite end spaced apart from the one end of the protruding area in the second direction and protruding to the one side in the first direction.

17. The battery cell stack of claim 16, wherein the protruding area is bent between the one end of the protruding area and the opposite end of the protruding area.

18. The battery cell stack of claim 17, wherein:
a portion of the flange area is cut away to define a cutaway portion; and
the protruding area has a shape in which the cutaway portion of the flange area is bent to have a curved surface.

19. The battery cell stack of claim 17, wherein the protruding area further comprises a protruding/extending area extending in the second direction between the one end of the protruding area and the opposite end of the protruding area.

20. The battery cell stack of claim 19, wherein the protruding area comprises:
a first protruding area extending from the one end of the protruding area to the one side in the first direction;
a second protruding area extending from the first protruding area in the second direction; and
a third protruding area extending from the second protruding area to the one side in the first direction.
